(19) United States
(12) Patent Application Publication
(10) Pub. No.: US 2004/0240215 A1
(43) Pub. Date: Dec. 2, 2004

(54) Easy assembling and disassembling lamp

(75) Inventor: Ying-Ming Lu, Taipei (TW)

Correspondence Address: BACON & THOMAS, PLLC, 625 SLATERS LANE, FOURTH FLOOR, ALEXANDRIA, VA, 22314

(73) Assignee: LON TAI SHING CO., LTD., Taipei (TW)

(21) Appl. No.: 10/448,390

(22) Filed: May 30, 2003

(51) Int. Cl. F21S 8/08

(52) U.S. Cl. 362/410; 362/457

(57) ABSTRACT

The present invention relates to an easy assembling and disassembling lamp whose lampshade and lamp arm are connected by screws to make it detachable and assembling. The present invention is characterized in that: the lampshade and the lamp arm are jointed with screws in place of traditional rivets, allowing for detachment; the one-piece long lamp arm are replaced with several short shafts assembled together to reduce its volume. In this way, the lamp can be detached and assembled, making warehousing and transportation more easily as well as reducing cost of transportation and saving space.

### FIELD OF THE INVENTION

The present invention relates to an easy assembling and dissembling lamp, wherein the lamp arm and the joint between the lamp arm and the lampshade are easy to assemble, facilitating packaging process, transit and warehousing as well as reduce the cost of transportation.

### BACKGROUND OF THE INVENTION

Traditional household lamps have a variety of styles and functions; however, there is still much for improvement in their structure and practicability. Their disadvantages are:

1. Despite of the strong and firm structure between the lampshade and the lamp arm and the timely rotation mechanism that makes it able to adjust the illuminating angle of the light, the immobile joint in-between prevents users from disassembling. The only way to disassemble the lamp is to damage the structure. Therefore, the whole lamp unable to disassemble would occupy lots of space.

2. The one-piece structure for traditional lamps has a large volume which becomes a waste of space during warehousing, transit and transportation. Meanwhile, such lamps require more packaging materials and have more transportation cost because its large volume requires more space of transportation. This not only increases the cost to the suppliers, but goes against the requirement of modern society.

### SUMMARY OF THE INVENTION

In view of such a situation, the inventor of the present invention was devoted to finding a solution and accomplished structural improvement for easy assembling and dissembling lamps, wherein the lampshade and the lamp arm are jointed by screws in place of traditional rivets, and the one-piece lamp arm are replaced with several short shafts assembled together, eliminating the disadvantages of unable to disassemble, occupying storage space and the inconvenience of transportation.

The main objective for the present invention is to provide an easy assembling and disassembling lamps that allows users to disassemble and assemble without using any tools, while maintains the firmness of the whole. Suitable for volume production, such designing consisting of detachable parts makes transportation more easily while saves storage space and reduces cost of transportation.

To achieve the above purpose, the present invention uses screws in place of traditional rivets to joint the lampshade and the lamp arm, allowing the two parts to disassemble easily. Meanwhile, the one-piece long lamp arms are replaced with several detachable lamp arms, reducing the volume of the whole equipment. Such designing has the following advantages:

1. The easy assembling and disassembling lamps for the present invention combines the lampshade and the lamp arm with screws, making disassembling faster, easier and more timesaving.

2. The easy assembling and disassembling lamps for the present invention replaces the one-piece long lamp arm with several short shafts connected with screws, allowing users to assemble and disassemble the equipment for storage and transportation, thus saves more space and reduce cost of transportation.

In the following, the embodiment illustrated is used to describe the detailed structural characteristics and operation action for the present invention.

### BRIEF DESCRIPTION OF THE DRAWINGS

FIG. 1 is an illustration for deformation of the lampshade and the lamp arm for the present invention.

FIG. 2 is an illustration for formation of the lampshade and the lamp arm for the present invention.

FIG. 3 is an illustration for deformation of the preferred embodiments of the lamp arm for the present invention.

FIG. 4 is an illustration for formation of FIG. 3.

FIG. 5 is an illustration for another preferred embodiments of the lamp arm for the present invention.

FIG. 6 is an illustration for partial deformation of FIG. 5.

### DETAILED DESCRIPTION OF THE INVENTION

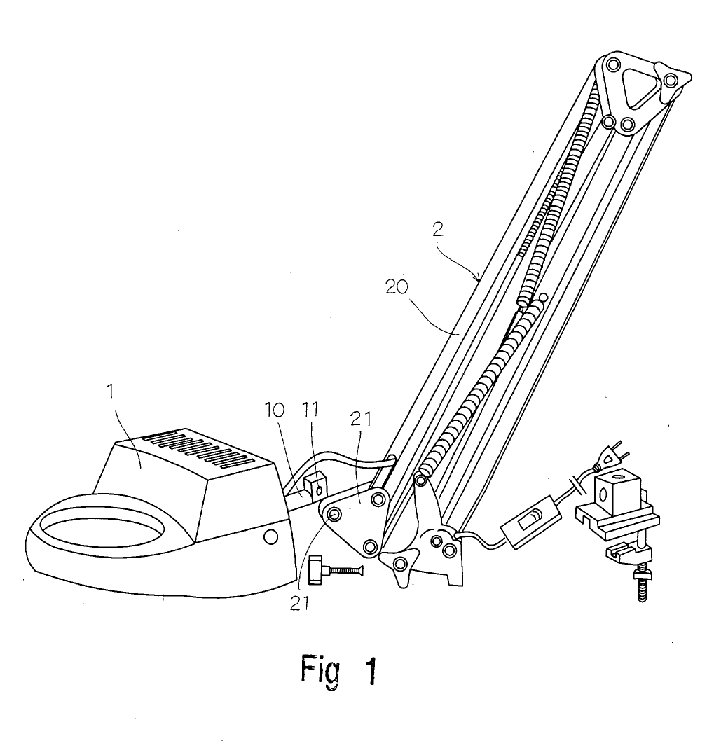

Please refer to FIG. 1. The easy assembling and disassembling lamp for the present invention mainly consists of a lampshade 1 and lamp arm 2.

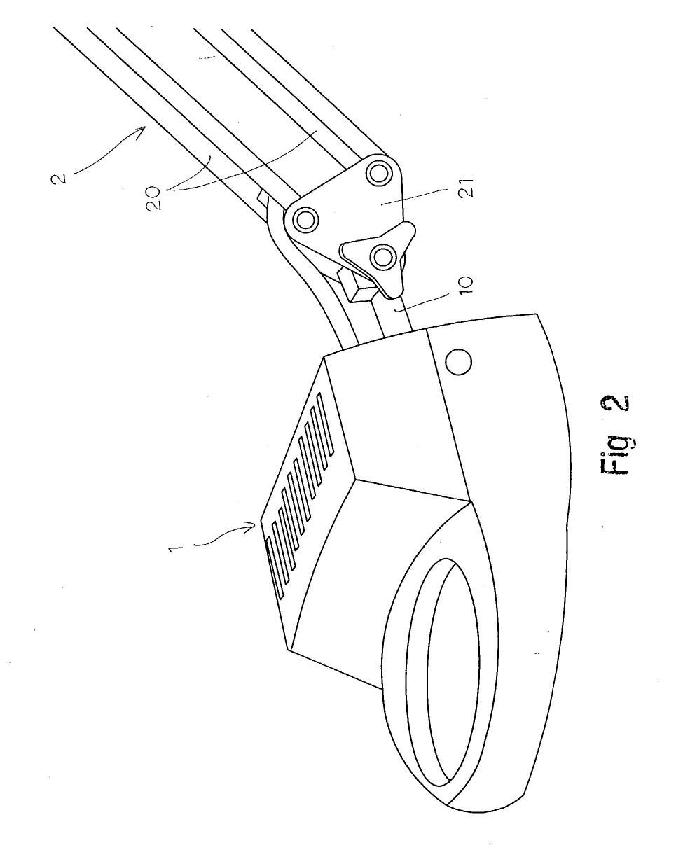

Please refer to FIG. 1 and FIG. 2 for the deformation of the joint between the lampshade 1 and the lamp arm 2. On the lampshade 1 there is a connecting rod 10 with a combining hole 11. The lamp arm 2 consists of several round shafts 20 of different diameters and length connected together, forming into long a double-shaft, lamp arm. On one end of the lamp arm 20 there is a triangular fixture 21 with several holes 211 on it, allowing for the round shafts being inserted to be fixed with screws. When the connecting rod 10 on the lampshade 1 is inserted through the fixture 21, the combining hole 11 then matches the holes 211 on the fixture, through which the screws are inserted, thus fixes the to whole components.

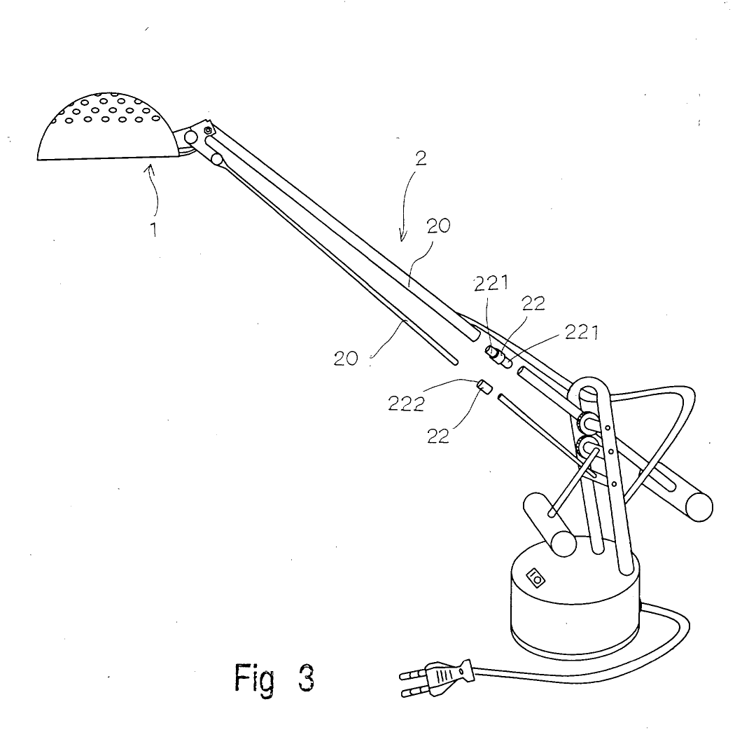

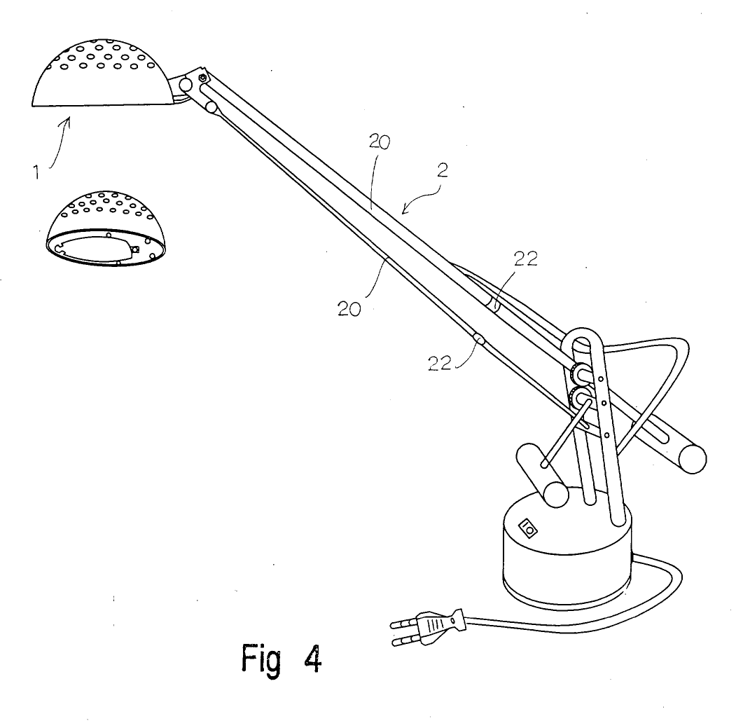

Please refer to FIG. 3 and FIG. 4. The long lamp arm 2 is composed of several round shafts 20 of different diameters and length combined together. The several round shafts 20 are connected with different types of connecting parts 22. The ends of the connecting part 22 for the round shafts of a larger diameter 20 are inserting ends 221 able to insert into the round shafts 20 while the ends of the connecting part 22 for the round shafts of a smaller diameter 20 are holes 222 allowing for the insertion of the round shafts 20. In this way, the round shafts 20 of different diameters can be easily assembled and disassembled.

By applying the above structure to ordinary lamps, an easy assembling and disassembling lamp is completed as in FIG. 1. This not only help suppliers reduce the use of packaging materials, but also save the space of storage, making transportation more easily, reducing the cost of transportation and then enhancing the competitiveness and usage of the lamp. Meanwhile, consumers can have the benefits of DIY through the easy assembling components.

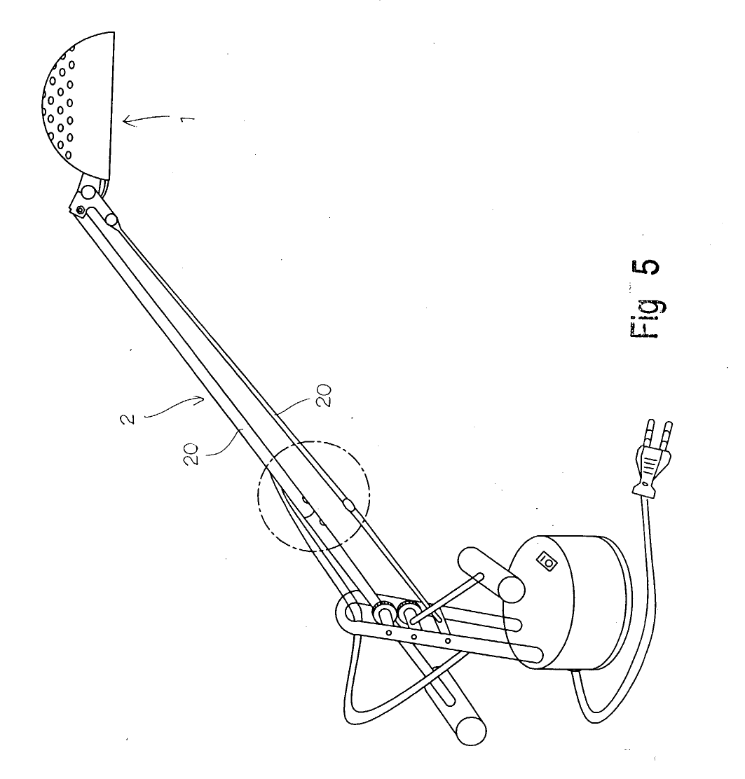

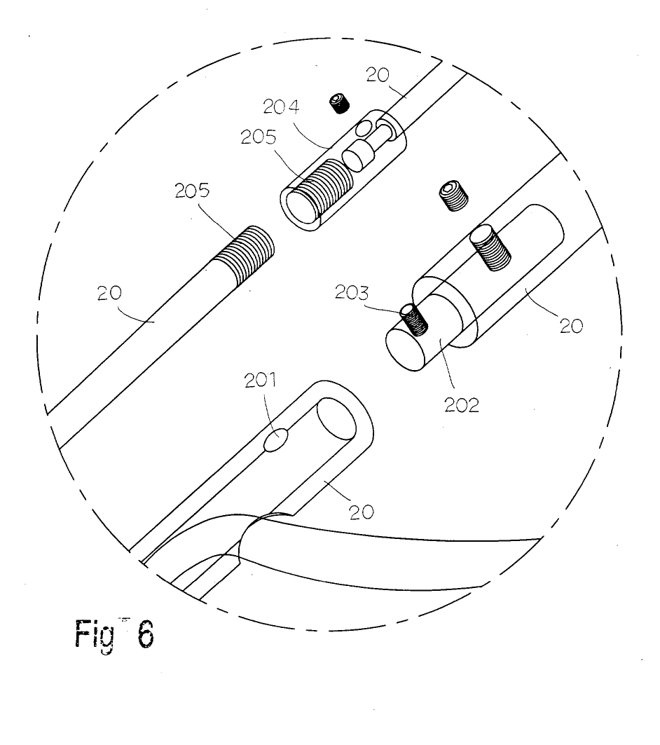

Beside the above connecting parts 22, there is also another type of connecting parts 22. Please refer to FIG. 5 and FIG. 6. Take the connection between two round shafts 20 of a larger diameter for example. On one of the round shafts' end there is a small hole 201 inside the shaft while the corresponding end of the other round shaft 20 has a plug 202. Passing a hexagonal screw through the plug 202 of the round shaft 20 can fix the two components. The plug 202 exposed out of the round shaft 20 has a flexible dowel 203. To connect the two round shafts 20 with each other, just inlaying the plug 202 of the round shaft into the end of the other shaft with the flexible dowel 203 of the plug passing through the small hole 201. In this way, the two round shafts are connected tightly.

In the case where the two round shafts 20 with a smaller diameter should be connected, there is a sleeve 204 on the edge of one end of a round shaft 20. Inside the sleeve 204 there are screw threads 205. The sleeve 204 is again fixed on the round shaft 20 with a hexagon screw. One the edge of the corresponding end of the other round shaft 20 there are several screw threads 205, allowing for connection through helix.

The joint between the lampshade and the lamp arm of the easy assembling and disassembling lamp for the present invention is done with screws in place of traditional rivets, allowing for detachment of lampshade and lamp arm. Replacing the long one-piece lamp arm with several short shafts combined together makes detachment, transportation and storage more convenient as well as saving the space for storage.

To summarize the above description, the easy assembling and disassembling lamp in the present invention can provide effective performance and extend its life through a simple structural improvement, which practically meets the qualifications for invention based on new type and improvement. Accordingly, an application is submitted for examination.

What is claimed is:

1. A structure to extend life for easy assembling and disassembling lamp, having a lampshade and lamp arm, characterized in that:
on said lampshade there is a connecting rod with a hole; said lamp arm is formed by several short round shafts of different diameters and length; on one end of said lamp arm there is a triangular fixture with several holes on said fixture, allowing for screws to pass through and lock tightly; one of said holes on said fixture matches said hole on said connecting rod of said lampshade passing through, allowing screws to pass through and lock tightly.

2. A structure to extend life for easy assembling and disassembling lamp, having a lampshade and lamp arm, characterized in that:
said short shafts are connected with different types of connecting parts, wherein round shafts of larger diameter are combined with a connecting part, ends of said connecting part can be inserted to said round shafts, while round shafts of smaller diameter are connected with a connecting part, ends of said connecting part allow for insertion of said round shafts.

3. A structure to extend life for easy assembling and disassembling lamp, having a lampshade and lamp arm, characterized in that:
said short round shafts can be combined with another type of connecting parts, wherein for said round shafts with larger diameter, a hole is placed inside one end of one of said round shaft and a plug inside a corresponding end of the other round shaft; a flexible dowel is placed on said plug exposed out of said round shaft; for said round shafts of smaller diameter, a sleeve having screw threads inside is placed on one end of said round shaft, while a corresponding end of the other round shaft also has screws threads, allowing said two round shafts to joint by helix.
